(19) United States
(12) Patent Application Publication
(10) Pub. No.: US 2025/0181969 A1
(43) Pub. Date: Jun. 5, 2025

(54) TECHNIQUES FOR TRAINING MACHINE LEARNING MODELS USING SYNTHETICALLY GENERATED DATA

(71) Applicant: NVIDIA CORPORATION, Santa Clara, CA (US)

(72) Inventors: Bowen WEN, Bellevue, WA (US); Stanley BIRCHFIELD, Sammamish, WA (US); Wei YANG, Lake Forest Park, WA (US); Jan KAUTZ, Lexington, MA (US)

(21) Appl. No.: 18/733,371

(22) Filed: Jun. 4, 2024

Related U.S. Application Data
(60) Provisional application No. 63/606,351, filed on Dec. 5, 2023.

(51) Int. Cl. G06N 20/00

(52) U.S. Cl. CPC G06N 20/00

(57) ABSTRACT

One embodiment of a method for generating data to train a machine learning model includes generating a prompt based on a template and information associated with an object, generating, via a first machine learning model and based on the prompt, a text description of at least one of a texture or a geometry for the object, generating, via a second machine learning model and based on the text description, the at least one of the texture or the geometry for the object, and performing one or more rendering operations based on the at least one of the texture or the geometry for the object to generate one or more rendered images.

### CROSS-REFERENCE TO RELATED APPLICATIONS

This application claims priority benefit of the U.S. Provisional Patent Application titled, “TECHNIQUES FOR LANGUAGE-AIDED SYNTHETIC DATA AUGMENTATION,” filed on Dec. 5, 2023 and having Ser. No. 63/606,351. The subject matter of this related application is hereby incorporated herein by reference.

### BACKGROUND

### Technical Field

Embodiments of the present disclosure relate generally to computer science, artificial intelligence (AI), and machine learning and, more specifically, to techniques for training machine learning models using synthetically generated data.

### Description of the Related Art

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. Thereafter, the trained machine learning models can be used to guide decisions and/or perform actions related to the data and/or other similar data.

Training is the process of causing a machine learning model to learn from data, which is referred to as “training data,” using a learning algorithm. Various learning algorithms have been developed for training different types of machine learning models. For example, an artificial neural network can be trained using a backpropagation algorithm that uses gradient descent to update parameters of the artificial neural network in order to minimize a cost function.

One drawback of conventional approaches for training machine learning models is that, oftentimes, learning algorithms require a very large amount of training data, which may not be readily available in many cases. For example, to train an artificial neural network to detect objects within an image, numerous images of objects having different sizes, colors, orientations, and other properties could be required as the training data. All of the different combinations of image properties could require thousands of different images, and that many different images may not be readily available. A machine learning model that is trained using an insufficient amount of training data can end up being improperly trained. When the improperly trained machine learning models are deployed for use in real-world scenarios, the machine learning models may end up generating incorrect outputs and not being particularly useful in those real-world scenarios.

As the foregoing illustrates, what is needed in the art are more effective techniques for training machine learning models.

### SUMMARY

One embodiment of the present disclosure sets forth a computer-implemented method for generating data to train a machine learning model. The method includes generating a prompt based on a template and information associated with an object. The method also includes generating, via a first machine learning model and based on the prompt, a text description of at least one of a texture or a geometry for the object. The method further includes generating, via a second machine learning model and based on the text description, the at least one of the texture or the geometry for the object. In addition, the method includes performing one or more rendering operations based on the at least one of the texture or the geometry for the object to generate one or more rendered images.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques generate relatively large amounts of training data that is also relatively diverse. The training data can be used to train a machine learning model, after which the trained machine learning model can be used to generate outputs that are more correct relative to outputs generated using machine learning models that are trained using conventional techniques involving smaller amounts of training data and/or less diverse training data. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the data generating server of FIG. 1, according to various embodiments;

FIG. 3 is a more detailed illustration of the training data generator of FIG. 1, according to various embodiments;

FIG. 4 illustrates an exemplar synthetically generated image, according to various embodiments; and

FIG. 5 is a flow diagram of method steps for generating training data for training a machine learning model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for training machine learning models using synthetically generated data. In some embodiments, a training data generator receives the geometry of an object and associated information about the object. Using a template, the training data generator generates a prompt that asks a language model to describe a texture of the object. The training data generator inputs the prompt into the language model to generate a description of the object texture. Then, the training data generator inputs the description of the object texture and a randomly initialized noisy texture into a diffusion model to generate a texture of the object. Thereafter, the training data generator renders images of the object having the generated texture in one or more simulation environments. In addition, the training data generator can generate any number of additional textures for other object(s) and render any number of images of the objects. A machine learning model can then be trained using the rendered image(s) and data generated during the rendering(s).

The techniques for training machine learning models have many real-world applications. For example, those techniques could be used to train a machine learning model to detect objects within images. As another example, those techniques could be used to train a machine learning model to segment objects within images. As a further example, those techniques could be used to train a machine learning model to describe objects within images.

The above examples are not in any way intended to be limiting. As persons skilled in the art will appreciate, as a general matter, the techniques for training machine learning models described herein can be implemented in any suitable application.

### System Overview

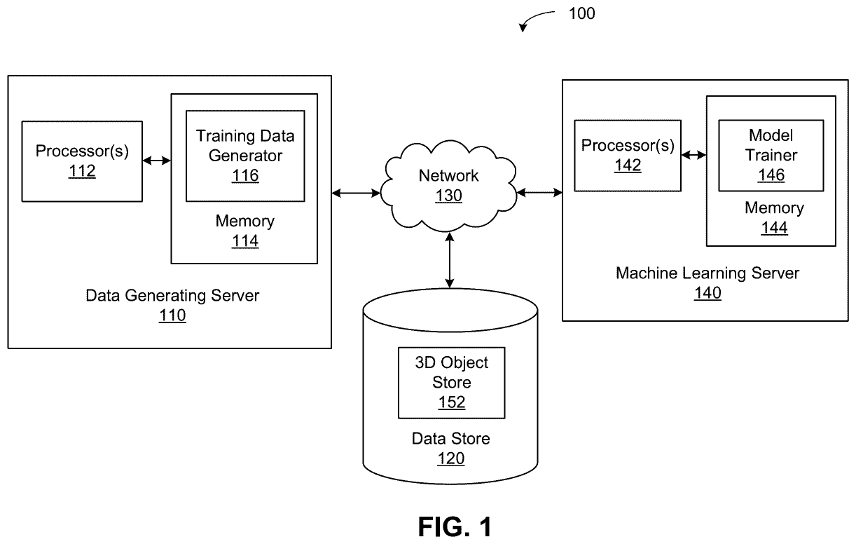

FIG. 1 illustrates a block diagram of a computer-based system 100 configured to implement one or more aspects of at least one embodiment. As shown, the system 100 includes a data generating server 110 and a machine learning server 140 that are in communication over a network 130. The network 130 can be a local area network (LAN), a wide area network (WAN) such as the Internet, a cellular network, and/or any other suitable network.

As shown, a training data generator 116 executes on one or more processors 112 of the data generating server 110 and is stored in a system memory 114 of the data generating server 110. Processor(s) 112 can receive user input from input devices, such as a keyboard or a mouse. In operation, the processor(s) 112 may include one or more primary processors of the data generating server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the data generating server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, storage (not shown) can supplement or replace the system memory 114. The storage can include any number and type of external memories that are accessible to the processor(s) 112, GPUs and/or other processing units. For example, and without limitation, the storage can include one or more of a Secure Digital Card, an external Flash memory, a portable compact disc read-only memory (CD-ROM), an optical storage device, a magnetic storage device, and/or any suitable combination of the foregoing.

The data generating server 110 shown herein is for illustrative purposes only, and variations and modifications are possible without departing from the scope of the present disclosure. For example, the number of processor(s) 112, the number of GPUs and/or other processing unit types, the number of system memories 114, and/or the number of applications included in the system memories 114 can be modified as desired. Further, the connection topology between the various units in FIG. 1 can be modified as desired. In some embodiments, any combination of the processor(s) 112, the system memory 114, GPU(s), and/or other processors can be included in and/or replaced with any type of virtual computing system, distributed computing system, and/or cloud computing environment, such as a public, private, or a hybrid cloud system.

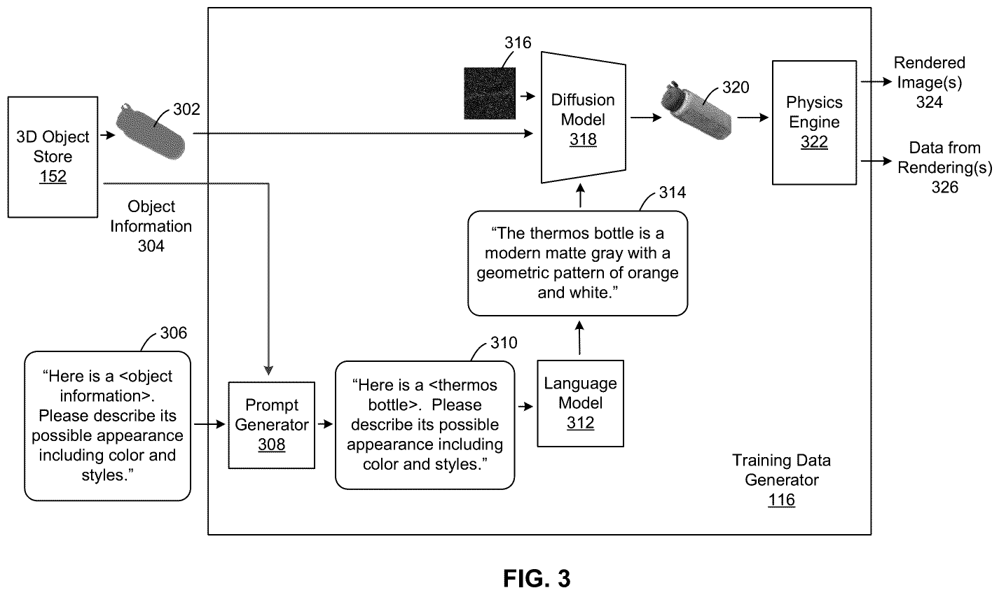

In some embodiments, the training data generator 116 generates training data that can be used to train machine learning models. Techniques employed by the training data generator 116 to generate training data are discussed in greater detail below in conjunction with FIGS. 3-5. In some embodiments, training data and/or trained (or deployed) machine learning models can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the data store 120 can be included in one or more of the data generating server 110 and/or the machine learning server 140.

As shown, a model trainer 116 is configured to train one or more machine learning models using training data that is generated by the training data generators 116. Illustratively, the model trainer 116 is stored in a system memory 144, and executes on processor(s) 142, of the machine learning server 140. In some embodiments, the system memory 144 and the processor(s) 142 of the machine learning server 140 can be similar to the system memory 114 and the processor(s) 112 of the data generating server 110, described above. Although the training data generator 116 and the model trainer 146 are shown as separate applications for illustrative purposes, in some embodiments, functionality of the training data generator 116 and the model trainer 146 can be implemented by any number of applications executing on any number of computing devices.

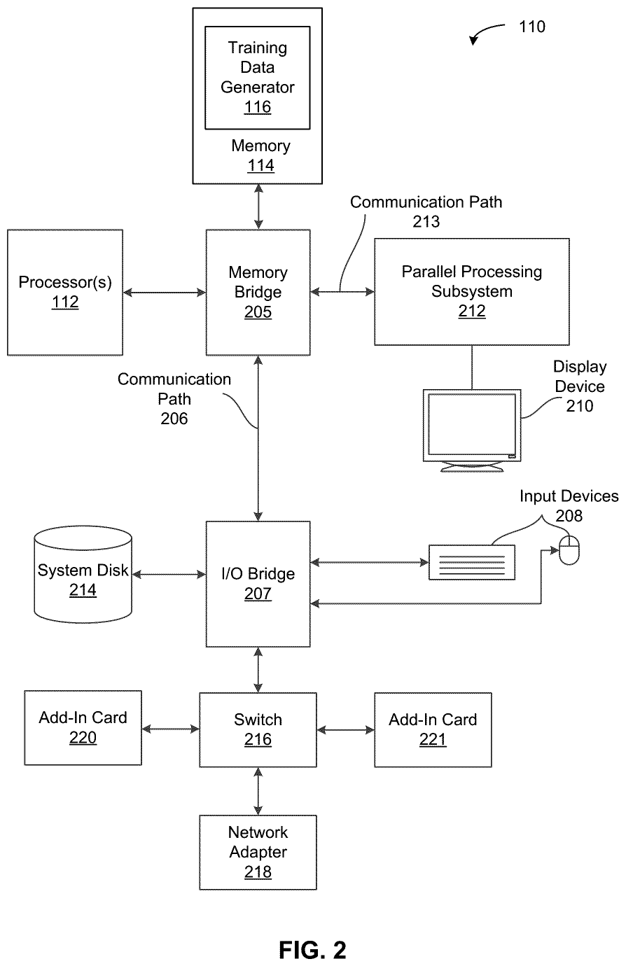

FIG. 2 is a block diagram illustrating the data generating server 110 of FIG. 1 in greater detail, according to various embodiments. Data generating server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the data generating server 110 is a server machine operating in a data center or a cloud computing environment that provides scalable computing resources as a service over a network. In some embodiments, the machine learning server 140 of FIG. 1 can include similar components as the data generating server 110.

In various embodiments, the data generating server 110 includes, without limitation, the processor(s) 112 and the memory (ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the data generating server 110 may be a server machine in a cloud computing environment. In such embodiments, the data generating server 110 may not include input devices 208, but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the data generating server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within data generating server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, the system memory 114 includes the training data generator 116. Although described herein primarily with respect to the training data generator 116, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

In some embodiments, processor(s) 112 includes the primary processor of data generating server 110, controlling and coordinating operations of other system components. In some embodiments, the processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on virtual machine(s) (VM(s)) executing on a server machine(s) whose GPU(s) and other physical resources are shared across one or more VMs.

### Training Machine Learning Models Using Synthetically Generated Data

FIG. 3 is a more detailed illustration of the training data generator 116 of FIG. 1, according to various embodiments. As shown, the training data generator 116 includes a prompt generator 308, a language model 312, a diffusion model 318, and a physics engine 322. Although the language model 312 and the diffusion model 318 are shown as being included in the training data generator 116, in some embodiments, the training data generator 116 can instead communicate via, e.g., one or more application programming interfaces (APIs) with a language model and/or a diffusion model that executes elsewhere, such as in a cloud computing environment. Although described herein with respect to the language model 312 and the diffusion model 318 as reference examples, in some embodiments, any technically feasible machine learning models can be used in lieu of the language model 312 and the diffusion model 318.

In operation, the training data generator 116 receives as input 3D geometry 302 of an object, shown as a thermos bottle, and information about the object 304 (“object information 304”). Illustratively, the geometry 302 and the object information 304 are retrieved from the 3D object store 152. In some embodiments, the 3D object store 152 can store the geometry, texture, and/or information for any number of objects, such as multiple objects for which the geometry and texture were created manually, as well as information describing the objects. For example, in some embodiments, a 3D object store can be chosen that provides a large number of daily-life objects with reasonable quality, as well as diversity of shapes and appearances. In some embodiments, when the 3D object store 152 also stores the textures for objects, such textures can be used along with synthetically generated textures to render images, as discussed in greater detail below. In addition, the training data generator 116 receives as input a template 306 for generating prompts to the language model 312. Given such inputs, the prompt generator 308 processes the template 306 and the object information 304 to generate a prompt 310 that includes text from the template 306 and the object information 304. Illustratively, the text from the template 306 includes the text “Here is a < >. Please describe its possible appearance including color and styles.” Further, the object information 304 includes a tag of “thermos bottle” that is associated with the geometry 302 and retrieved from the 3D object store 152. Given such the template 306 and the object information 304, the prompt generator 308 inserts the tag from the object information 304 into the text from the template 306 to generate the prompt 310 that includes the text “Here is a <thermos bottle>. Please describe its possible appearance including color and styles.”

After generating the prompt 310, the training data generator 116 inputs the prompt 310 into the language model 312, which outputs a description 314 of a texture for the object. In some embodiments, the language model 312 can be a large language model (LLM). Illustratively, the description 314 includes the text “The thermos bottle is a modern matte gray with a geometric pattern of orange and white.” Although one description 314 is shown for illustrative purposes, the prompt 310 can be input into the language model 312 any number of times to generate any number of descriptions of different textures for the object. For example, in some embodiments, the language model 312 also receives a random seed along with the prompt 310, such that the language model 312 generates different descriptions of textures for the object each time the prompt 310 and a different random seed is input into the language model 312.

After generating the description of the texture 314 for the object, the training data generator 116 inputs the description of the texture 314, the geometry 312 of the object, and a randomly initialized noisy texture 316 into the diffusion model 318. Given such inputs, the diffusion model 318 generates a texture 320 for the object. The texture 320 corresponds to the description of the texture 314. In some embodiments, the diffusion model 318 first determines a UV mapping for the object represented by the geometry 312, and then the diffusion model 318 generates a texture that is compatible with the UV mapping via a denoising diffusion technique. Any technically feasible diffusion model 318, including known diffusion models, can be used in some embodiments.

Using the texture 320 generated by the diffusion model 318, the training data generator 116 renders one or more images 324 that include the object having the texture 320. In some embodiments, the training data generator 116 randomly selects the lighting, virtual camera pose, number of objects, object materials, and/or object sizes to use for rendering images, such as the image 400. Then, the training data generator 116 can drop the selected number of objects, each of which is represented by an associated geometry and a generated texture, into a virtual environment. Interactions of the objects within the virtual environment are simulated using the physics engine 322. The physics engine 322 performs a gravity and physics simulation that can account for physical forces, friction, and/or the like experienced by the objects within the virtual environment to generate physically plausible scenes. In addition, the physics engine 322 renders, such as via a path tracing or any other suitable technique that produces high-fidelity photo-realistic renderings, image(s) 324 of the object(s) in the virtual environment using the selected lighted and virtual camera pose. In some embodiments, the image(s) 324 can include one or more RGBD (red, green, blue, depth) images. Although described herein primarily with respect to the physics engine 322 rendering the images and generating the associated data, in some embodiments, images can be rendered separately from the physics simulation by the physics engine 322. In addition, physics engine 322 generates data 326 associated with the rendering(s). In some embodiments, the data 326 can include any suitable data that can be used along with the rendered image(s) 324 to train one or more machine learning models. The data 326 is known to the physics engine 322 that simulations the positions, orientations, etc. of object(s) in the rendered image(s). For example, in some embodiments, the data 326 can include information indicating the location(s) of object(s) within the rendered image(s), segmentations of object(s) within the rendered image(s), text describing the object(s) within the rendered image(s), etc. In such cases, the information indicating the location(s) of object(s) can be used along with the rendered image(s) to train a machine learning model to detect those object(s) within images. As another example, the segmentations of object(s) can be used along with the rendered image(s) to train a machine learning model to segment objects within images. As a further example, the text describing object(s) and information indicating the location(s) of objects can be used along with the rendered image(s) to train a visual language model to describe the positions of objects within images. The machine learning model can be trained in any technically feasible manner. For example, when the machine learning model is an artificial neural network, the artificial neural network could be trained using the training data, described above, and backpropagation with gradient descent, or a variation thereof. Further, the machine learning model can be trained using supervised learning, semi-supervised learning, or reinforcement learning in some embodiments, and the machine learning model can be trained to generate any suitable output.

More specifically, in some embodiments, the training data generator 116 randomly samples a number (e.g., 70 to 90) objects and drops the sampled objects onto a platform with invisible walls until the object velocities were smaller than a threshold. Then, the training data generator 116 randomly scales the objects (e.g., from 5 to 30 cm) and randomly samples the size of the platform (e.g., between 1 to 1.5 meters). The training data generator 116 then applies the generated textures, described above, to each object with a number (e.g., 3 to 5) different seeds for various styles. To produce diverse and photorealistic images, the training data generator 116 can also create a number (e.g., 0 to 5) lights with varied size, color, intensity, temperature, and/or exposure, and a number (e.g., 2) of cameras on a hemisphere with a randomly selected radius (e.g., between 0.2 to 3.0 meter) hanging above the platform. In addition, the training data generator 116 can randomize the material properties, including metallicness and reflection, and textures of the objects and the platform. For the virtual environment, a dome light with a random orientation and a sampled background can be used. Then, the training data generator 116 can render RGBD images of the scene after a gravity and physics simulation is performed, and the training data generator 116 can store corresponding data such as object segmentation, camera parameters, and the object poses, and the like.

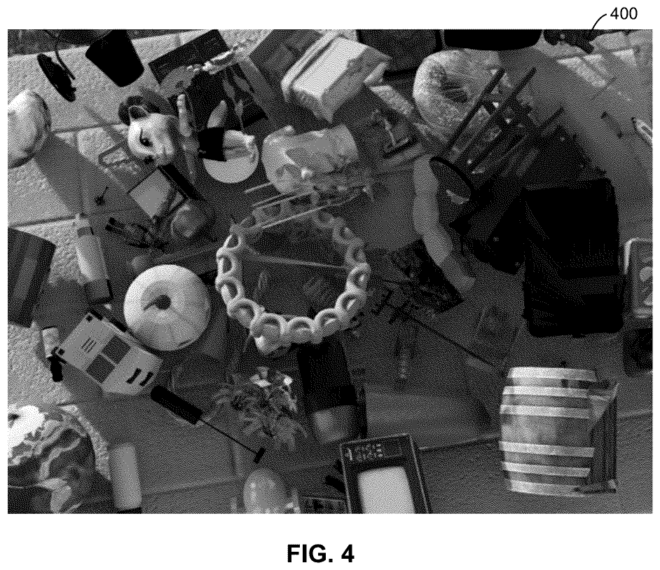

FIG. 4 illustrates an exemplar synthetically generated image 400, according to various embodiments. As shown, the image 400 includes a number of objects having generated textures. As described, in some embodiments, the training data generator 116 can randomly select the lighting, virtual camera pose, number of objects, object materials, and/or object sizes to use for rendering. In addition, the training data generator 116 can simulate interactions of the objects within a virtual environment using the physics engine 322 and render, such as via a path tracing or any other suitable technique, one or more images (e.g., the image 400) of the object(s) in the virtual environment using the selected lighted and virtual camera pose.

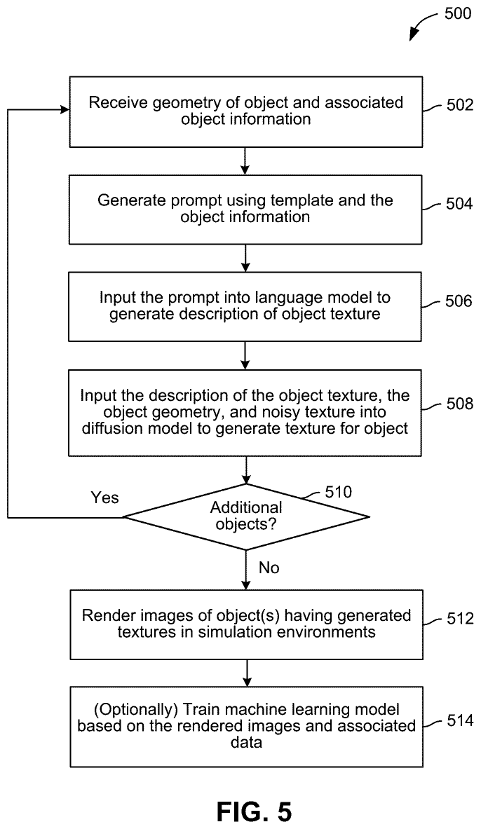

FIG. 5 is a flow diagram of method steps for generating training data for training a machine learning model, according to various embodiments. Although the method steps are described in conjunction with the systems of FIGS. 1-3, persons skilled in the art will understand that any system configured to perform the method steps in any order falls within the scope of the present embodiments.

As shown, a method 500 begins at step 502, where the training data generator 116 receives the geometry of an object and associated information about the object. In some embodiments, the object geometry and associated information can be retrieved from a 3D object store (e.g., 3D object store) or any other suitable source. Although described herein primarily with respect to receiving object geometry and associated information and generating textures, in some embodiments, geometry can also be generated for objects. In such cases, the training data generator 116 may not receive the geometry of objects as input.

At step 504, the training data generator 116 generates a prompt using a template and the object information. In some embodiments, the training data generator 116 can combine text from the template and text from the object information, such as inserting the text from the object information into predefined location(s) within the text from the template, as described above in conjunction with FIG. 3.

At step 506, the training data generator 116 inputs the prompt into a language model to generate a description of an object texture. Although described with respect to generating a single object texture for simplicity, in some embodiments, the training data generator 116 can input the prompt into the language model any number of times to generate any number of descriptions of different textures.

At step 508, the training data generator 116 inputs the description of the object texture, the geometry of the model, and a randomly initialized noisy texture into a diffusion model to generate a texture for the object. In some embodiments, given the geometry of the model, the training data generator 116 first generates a texture image with UV mapping. Then, by initializing that image with noise, the denoising diffusion steps performed by the diffusion model iteratively refine the texture image with UV mapping into a texture image output. Thereafter, the texture image can be wrapped onto the geometry of the model (e.g., a mesh) to make a textured geometry (e.g., a textured mesh).

At step 510, if there are additional objects to process, then the method 500 returns to step 502, where the training data generator 116 receives the geometry of another object and associated information about the other object.

On the other hand, if there are no additional objects to process, then the method 500 continues to step 512, where the training data generator 116 renders images of object(s) having the generated textures in simulation environments. The training data generator 116 can render the images in any technically feasible manner in some embodiments. In some embodiments, the training data generator 116 can drop a number of objects, each of which is represented by an associated geometry and a generated texture, into a virtual environment, perform a physics simulation of the objects within the virtual environment, and then render one or more RGBD images of the objects in the virtual environment using randomly selected lighting and virtual camera pose(s). In addition, the training data generator 116 can generate data associated with the renderings, such as information indicating the location(s) of object(s) within the rendered image(s), segmentations of object(s) within the rendered image(s), text describing the object(s) within the rendered image(s), and/or any other suitable data that can be used to train machine learning models.

At step 514, the model trainer 146 optionally trains a machine learning model based on the rendered images and the associated data. In some embodiments, any number of machine learning models can be trained using rendered images and associated data that are generated according to technique disclosed herein. For example, in some embodiments, one or more artificial neural networks can be trained using (1) training data that includes the rendered images and associated data, and (2) backpropagation with gradient descent, or a variation thereof. Further, the machine learning model can be trained using supervised learning, semi-supervised learning, or reinforcement learning in some embodiments, and the machine learning model can be trained to generate any suitable output.

In sum, techniques are disclosed for generating synthetic data for training machine learning models. In some embodiments, a training data generator receives the geometry of an object and associated information about the object. Using a template, the training data generator generates a prompt that asks a language model to describe a texture of the object. The training data generator inputs the prompt into the language model to generate a description of the object texture. Then, the training data generator inputs the description of the object texture and a randomly initialized noisy texture into a diffusion model to generate a texture of the object. Thereafter, the training data generator renders images of the object having the generated texture in one or more simulation environments. In addition, the training data generator can generate any number of additional textures for other object(s) and render any number of images of the objects. A machine learning model can then be trained using the rendered image(s) and data generated during the rendering(s).

At least one technical advantage of the disclosed techniques relative to the prior art is that the disclosed techniques generate relatively large amounts of training data that is also relatively diverse. The training data can be used to train a machine learning model, after which the trained machine learning model can be used to generate outputs that are more correct relative to outputs generated using machine learning models that are trained using conventional techniques involving smaller amounts of training data and/or less diverse training data. These technical advantages represent one or more technological improvements over prior art approaches.

1. In some embodiments, a computer-implemented method for generating data to train a machine learning model comprises generating a prompt based on a template and information associated with an object, generating, via a first machine learning model and based on the prompt, a text description of at least one of a texture or a geometry for the object, generating, via a second machine learning model and based on the text description, the at least one of the texture or the geometry for the object, and performing one or more rendering operations based on the at least one of the texture or the geometry for the object to generate one or more rendered images.

2. The computer-implemented method of clause 1, further comprising performing one or more operations to train a third machine learning model based on the one or more rendered images.

3. The computer-implemented method of clauses 1 or 2, further comprising generating data associated with the one or more rendered images, wherein the data associated with the one or more rendered images includes at least one of a location, a segmentation, or a text description of the object within each image included in the one or more rendered images.

4. The computer-implemented method of any of clauses 1-3, wherein performing the one or more rendering operations comprises simulating, via a physics simulator, the object within a virtual environment based on the at least one of the texture or the geometry for the object.

5. The computer-implemented method of any of clauses 1-4, wherein performing the one or more rendering operations is further based on at least one of a selected lighting, a selected virtual camera pose, or a selected number of other objects.

6. The computer-implemented method of any of clauses 1-5, further comprising retrieving the information associated with the object from a database that stores at least one of a predefined texture or a predefined geometry for the object.

7. The computer-implemented method of any of clauses 1-6, wherein generating the at least one of the texture or the geometry for the object comprises inputting, into the second machine learning model, the text description, a predefined geometry for the object, and a noisy texture.

8. The computer-implemented method of any of clauses 1-7, wherein the prompt asks the second machine learning model to describe the at least one of the texture or the geometry for the object.

9. The computer-implemented method of any of clauses 1-8, wherein the first machine learning model comprises a language model.

10. The computer-implemented method of any of clauses 1-9, wherein the second machine learning model comprises a diffusion model.

11. In some embodiments, one or more non-transitory computer-readable media store instructions that, when executed by at least one processor, cause the at least one processor to perform the steps of generating a prompt based on a template and information associated with an object, generating, via a first machine learning model and based on the prompt, a text description of at least one of a texture or a geometry for the object, generating, via a second machine learning model and based on the text description, the at least one of the texture or the geometry for the object, and performing one or more rendering operations based on the at least one of the texture or the geometry for the object to generate one or more rendered images.

12. The one or more non-transitory computer-readable media of clause 11, wherein the instructions, when executed by the at least one processor, further cause the at least one processor to perform the step of performing one or more operations to train a third machine learning model based on the one or more rendered images.

13. The one or more non-transitory computer-readable media of clauses 11 or 12, wherein the instructions, when executed by the at least one processor, further cause the at least one processor to perform the step of generating data associated with the one or more rendered images, wherein the data associated with the one or more rendered images includes at least one of a location, a segmentation, or a text description of the object within each image included in the one or more rendered images.

14. The one or more non-transitory computer-readable media of any of clauses 11-13, wherein performing the one or more rendering operations comprises simulating, via a physics simulator, the object within a virtual environment based on the at least one of the texture or the geometry for the object.

15. The one or more non-transitory computer-readable media of any of clauses 11-14, wherein performing the one or more rendering operations is further based on at least one of a selected lighting, a selected virtual camera pose, or a selected number of other objects.

16. The one or more non-transitory computer-readable media of any of clauses 11-15, wherein the instructions, when executed by the at least one processor, further cause the at least one processor to perform the step of performing one or more operations to randomly select the at least one of the selected lighting, the selected virtual camera pose, or the selected number of other objects.

17. The one or more non-transitory computer-readable media of any of clauses 11-16, wherein the prompt asks the second machine learning model to describe the at least one of the texture or the geometry for the object.

18. The one or more non-transitory computer-readable media of any of clauses 11-17, wherein the first machine learning model comprises a large language model.

19. The one or more non-transitory computer-readable media of any of clauses 11-18, wherein the second machine learning model comprises a diffusion model.

20. In some embodiments, a system comprises one or more memories storing instructions, and one or more processors that are coupled to the one or more memories and, when executing the instructions, are configured to generate a prompt based on a template and information associated with an object, generate, via a first machine learning model and based on the prompt, a text description of at least one of a texture or a geometry for the object, generate, via a second machine learning model and based on the text description, the at least one of the texture or the geometry for the object, and perform one or more rendering operations based on the at least one of the texture or the geometry for the object to generate one or more rendered images.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating data to train a machine learning model, the method comprising:
generating a prompt based on a template and information associated with an object;
generating, via a first machine learning model and based on the prompt, a text description of at least one of a texture or a geometry for the object;
generating, via a second machine learning model and based on the text description, the at least one of the texture or the geometry for the object; and
performing one or more rendering operations based on the at least one of the texture or the geometry for the object to generate one or more rendered images.

2. The computer-implemented method of claim 1, further comprising performing one or more operations to train a third machine learning model based on the one or more rendered images.

3. The computer-implemented method of claim 1, further comprising generating data associated with the one or more rendered images, wherein the data associated with the one or more rendered images includes at least one of a location, a segmentation, or a text description of the object within each image included in the one or more rendered images.

4. The computer-implemented method of claim 1, wherein performing the one or more rendering operations comprises simulating, via a physics simulator, the object within a virtual environment based on the at least one of the texture or the geometry for the object.

5. The computer-implemented method of claim 1, wherein performing the one or more rendering operations is further based on at least one of a selected lighting, a selected virtual camera pose, or a selected number of other objects.

6. The computer-implemented method of claim 1, further comprising retrieving the information associated with the object from a database that stores at least one of a predefined texture or a predefined geometry for the object.

7. The computer-implemented method of claim 1, wherein generating the at least one of the texture or the geometry for the object comprises inputting, into the second machine learning model, the text description, a predefined geometry for the object, and a noisy texture.

8. The computer-implemented method of claim 1, wherein the prompt asks the second machine learning model to describe the at least one of the texture or the geometry for the object.

9. The computer-implemented method of claim 1, wherein the first machine learning model comprises a language model.

10. The computer-implemented method of claim 9, wherein the second machine learning model comprises a diffusion model.

11. One or more non-transitory computer-readable media storing instructions that, when executed by at least one processor, cause the at least one processor to perform the steps of:
generating a prompt based on a template and information associated with an object;
generating, via a first machine learning model and based on the prompt, a text description of at least one of a texture or a geometry for the object;
generating, via a second machine learning model and based on the text description, the at least one of the texture or the geometry for the object; and
performing one or more rendering operations based on the at least one of the texture or the geometry for the object to generate one or more rendered images.

12. The one or more non-transitory computer-readable media of claim 11, wherein the instructions, when executed by the at least one processor, further cause the at least one processor to perform the step of performing one or more operations to train a third machine learning model based on the one or more rendered images.

13. The one or more non-transitory computer-readable media of claim 11, wherein the instructions, when executed by the at least one processor, further cause the at least one processor to perform the step of generating data associated with the one or more rendered images, wherein the data associated with the one or more rendered images includes at least one of a location, a segmentation, or a text description of the object within each image included in the one or more rendered images.

14. The one or more non-transitory computer-readable media of claim 11, wherein performing the one or more rendering operations comprises simulating, via a physics simulator, the object within a virtual environment based on the at least one of the texture or the geometry for the object.

15. The one or more non-transitory computer-readable media of claim 11, wherein performing the one or more rendering operations is further based on at least one of a selected lighting, a selected virtual camera pose, or a selected number of other objects.

16. The one or more non-transitory computer-readable media of claim 15, wherein the instructions, when executed by the at least one processor, further cause the at least one processor to perform the step of performing one or more operations to randomly select the at least one of the selected lighting, the selected virtual camera pose, or the selected number of other objects.

17. The one or more non-transitory computer-readable media of claim 11, wherein the prompt asks the second machine learning model to describe the at least one of the texture or the geometry for the object.

18. The one or more non-transitory computer-readable media of claim 11, wherein the first machine learning model comprises a large language model.

19. The one or more non-transitory computer-readable media of claim 11, wherein the second machine learning model comprises a diffusion model.

20. A system, comprising:
one or more memories storing instructions; and
one or more processors that are coupled to the one or more memories and, when executing the instructions, are configured to:
generate a prompt based on a template and information associated with an object,
generate, via a first machine learning model and based on the prompt, a text description of at least one of a texture or a geometry for the object,
generate, via a second machine learning model and based on the text description, the at least one of the texture or the geometry for the object, and
perform one or more rendering operations based on the at least one of the texture or the geometry for the object to generate one or more rendered images.
